(19) United States
(12) Patent Application Publication
(10) Pub. No.: US 2011/0192355 A1
(43) Pub. Date: Aug. 11, 2011

(54) CANINE CONTROL CORD

(76) Inventor: Marijke Van Duyl-Spaargaren, Victoria (AU)

(21) Appl. No.: 13/124,301

(22) PCT Filed: Oct. 1, 2009
(86) PCT No.: PCT/AU2009/001295

§ 371 Date: Apr. 14, 2011

(30) Foreign Application Priority Data
Oct. 15, 2008 (AU) 2008905329

(51) Int. Cl. A01K 27/00

(52) U.S. Cl. 119/793

(57) ABSTRACT

A dog control device utilises a dog collar attached to an eye formed from one end of a leash so that when worn the eye lies at or near the lower cervical vertebrae. If the leash is passed around the dogs chest and through the eye, a loop is formed which encircles the dogs thorax. When the leash is tensioned, such as by the dog lunging, the loop tightens and the dog stops lunging. The eye is part of the collar. Alternatively, the eye is attached to a conventional collar by a ring. A stop is attached to the leash which is threadable through the eye during the formation of the loop but which resists passage through the eye in the opposite direction in order to maintain the loop.

### FIELD OF THE INVENTION

This invention concerns control cord devices for use by dog handlers.

### BACKGROUND OF THE INVENTION

Persons who exercise dogs by walking with them while the dog is on a leash encounter dogs who are difficult to control. Such dogs jump continually, pull on the leash, drop to the ground or refuse to walk. Such activities can be tiring for the handler. Unexpected jolts to the arm, shoulder and back are common. Large dogs and strong dogs give their owners such problems that ownership is eventually relinquished and the dogs are given up. This is an unsatisfactory conclusion for both owner and dog.

### SUMMARY OF THE INVENTION

A dog control device comprising a dog collar attached to an eye such that when worn, the eye lies at or near dorsal, lower cervical vertebrae, a leash attached to the eye, the purpose being to allow the formation of a loop encircling the dog's thorax by passage of the leash through the eye, whereby when the leash is tensioned, the loop tightens.

Preferably the eye overlies the C4 and C5 vertebrae. If it lies further along the spine than C5 the loop tends to move towards the abdomen and loses its ability to control. The ideal site for the loop is just caudal to the axilla around the fullest part of the thorax.

The eye may form part of a collar. In particular, the eye may join two ends of a collar. The collar may be non-stretch so as to assist in positioning the eye correctly. Accordingly, choke chains are not suitable if they allow the eye to travel rearwardly. The collar may be of the type closed by a buckle or closed by a squeeze, press-release clasp. The leash may be a braided cord. Such cords have a low friction surface which is conducive to rapid adjustment of the loop length. As soon as tension falls the loop enlarges and vice versa. A responsive leash imposes and quells loop tension and lively lunging is soon suppressed. Other cords are useful especially those of round cross section. Leashes made of leather or nylon strip are unsuitable in that they tend to damage the dog's skin. The part of the leash held by the handler may be covered by a thin plastic sheath or and equivalent.

The leash preferably has a stop between the eye and the person's end of the leash.

The stop may be a one-way arrester which is operable to pass through the eye in one direction but will not pass through in the opposite direction. The position of the stop on the leash is preferably adjustable by the handler. The purpose of the stop is to prevent the loop from enlarging unduly if tension is released. Enlargement of the loop allows the dog to step out of the loop requiring the handler to re-thread the eye. The stop can take different forms, for example it can be a pair of crossed arms which can fold together or open out. In a variant, the eye is not part of the collar but is attached thereto.

### BRIEF DESCRIPTION OF THE DRAWINGS

One embodiment of the invention is now described with reference to the accompanying drawings, in which:

FIG. 1 is a perspective of the device with a loop inserted.

FIG. 2 is a perspective of a variant where the eye is separate from the collar.

FIG. 3 is a plan of the device worn by a dog.

FIG. 4 is a side view of the device when worn by a dog.

### DETAILED DESCRIPTION WITH RESPECT TO THE DRAWINGS

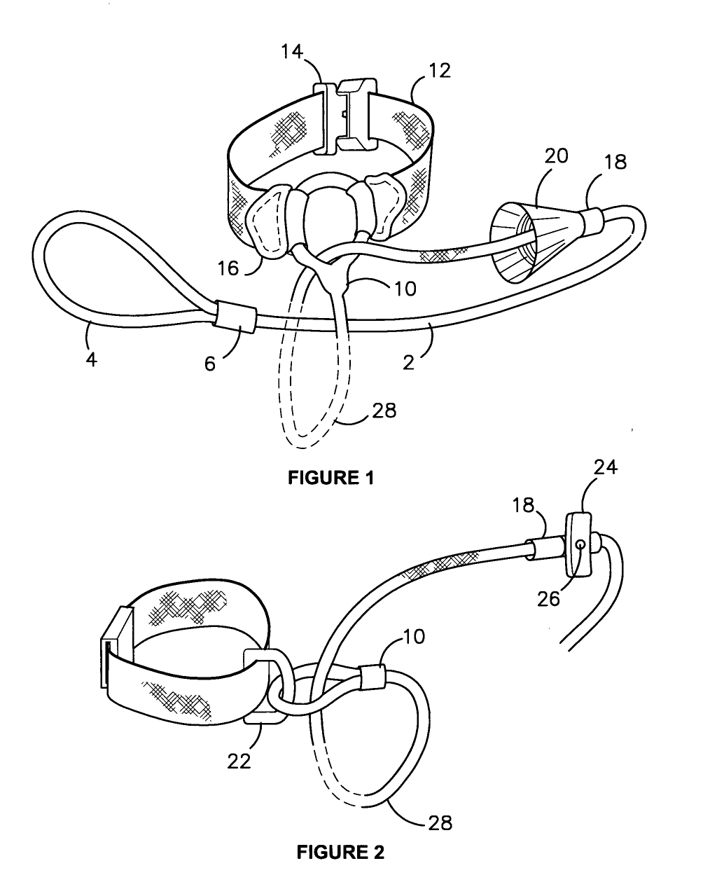

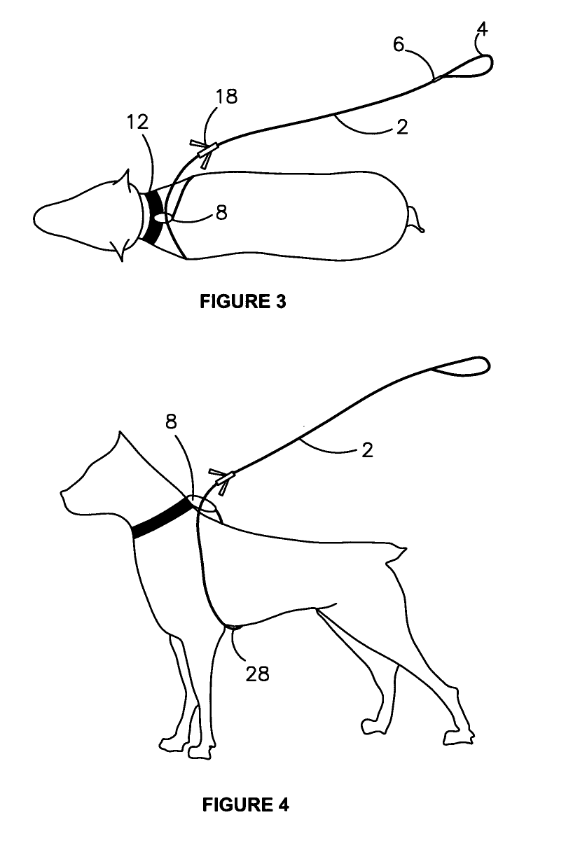

Referring now to FIGS. 1 and 2, the device has a leash 2 made from a 2.5 m length of braided cord 10 mm in diameter. Braiding permits a useful degree of stretch tending to lessen the discomfort of a sudden jolt, for both dog and handler. At one end is a hand loop 4 formed by a ferrule 6. At the opposite end is an eye 8, 50 mm in diameter formed by a second ferrule 10 (see FIG. 3). Cord 6 mm in diameter suffices for small dogs.

An adjustable collar 12 made from woven polyester ribbon 25 mm wide is closed by a plastic squeeze release clasp 14. The collar is split allowing the free ends to engage the eye 8. The ends wrap around opposite sites on the eye and are held by stitched rubber tabs 16. Collars narrower than 25 mm suit smaller dogs. About 1.1 m from the hand loop 4 is a rubber stop 18. This is a sleeve with diverging fingers 20, the tips of which lie on a circle 60 mm in diameter. This is a friction fit on the cord and can be pushed by hand to an appropriate position. The fingers 20 can be closed up by squeezing in order to feed them in the reverse direction through eye 8 if a tangle occurs or to prepare for the next application of the leash.

In a variant as shown in FIG. 2, the eye 8 is not part of the collar 12. The collar is unclasped to admit metal D-ring 22 which is attached to eye 8 before ferrule 10 is applied. Stop 18 has a cross arm 24 which has a frictional fastener 26 allowing it to lie parallel to the ferrule.

FIG. 3 shows how the handle loop 4 has been passed through the eye 8 and then the rubber stop 18 by squeezing the fingers to pass through the eye, whereafter they spontaneously diverge preventing the thoracic control loop 28 from reversing and disappearing.

In FIG. 4, the collar is shown around the dog's neck allowing the eye to rest on the dorsal part of cervical vertebra C4 and C5. The clasp 14 is closed. The handler holds the dog by the collar and repeats the sequence indicated in FIG. 4 by passing the handle loop 4 underneath the dog and feeding the handle loop and stop through eye 8 to form thoracic loop 28. The handler holds the leash and releases the collar.

As soon as the dog lunges forward the handler stands still and allows the thoracic loop to tighten. The faster the lunge, the faster the loop tightens and the stronger the restraining effect on the dog. If the dog drops or stops, the handler can tension the thoracic loop in order to warn or correct the dog. The loop tightening does not harm or traumatise the dog, but after several experiences the dog learns and in most cases will start to behave.

The collar can be slipped over the dogs head or fastened in the conventional way. When the dog pulls there is no pressure on the neck. All the tension is felt around the thorax. As soon as the dog stops pulling, the thoracic loop enlarges, the tension stops and comfort returns.

It is not understood why dogs respond to thoracic binding but not to neck binding when choke chains are used.

It is to be understood that the word “comprising” as used throughout the specification is to be interpreted in its inclusive form, ie. use of the word “comprising” does not exclude the addition of other elements.

it is to be understood that various modifications of and/or additions to the invention can be made without departing from the basic nature of the invention. these modifications and/or additions are therefore considered to fall within the scope of the invention.

1. A dog control device comprising a dog collar attached to an eye such that when worn, the eye lies at or near dorsal, lower cervical vertebrae, a leash attached to the eye, the purpose being to allow the formation of a loop encircling the dog's thorax by passage of the leash through the eye, whereby when the leash is tensioned, the loop tightens.

2. A dog control device as claimed in claim 1, wherein the eye forms part of a collar.

3. A dog control device as claimed in claim 1, wherein the eye joins two ends of a collar.

4. A dog control device as claimed in any one of claim 1, wherein the leash is a cord of round section.

5. A dog control device as claimed in claim 4, wherein the leash is a braided cord.

6. A dog control device as claimed in claim 1, wherein the collar closed by a squeeze, press-release clasp.

7. A dog control device as claimed in claim 1, wherein the leash has a stop located between the eye and the person's end of the leash.

8. A dog control device as claimed in claim 7, wherein the stop is a loop arrester which is operable to pass through the eye in one direction but will not pass through in the opposite direction.

9. A dog control device as claimed in claim 1, wherein the eye is separate from the collar but attached thereto.

10. A dog control device as claimed in claim 9, wherein the eye and collar are attached by a ring through which the collar is threadable.

11. A dog control device as claimed in claim 1, wherein the eye of the device when worn, lies opposite C4 and C5 vertebrae.
